(19) United States
(12) Patent Application Publication
(10) Pub. No.: US 2011/0213723 A1
(43) Pub. Date: Sep. 1, 2011

(54) AUDIO AGREEMENT

(75) Inventors: Susannette Burroughs, Mountain View, CA (US); Sharon K. Matsumura, Palo Alto, CA (US)

(73) Assignee: INTUIT INC., Mountain View, CA (US)

(21) Appl. No.: 12/714,212

(22) Filed: Feb. 26, 2010

(51) Int. Cl. G06Q 99/00; G06Q 10/00; H04M 1/64

(52) U.S. Cl. 705/318; 379/88.22; 379/88.05

(57) ABSTRACT

A method for providing a product use agreement. The method includes sending, to a user in response to a request for a product, a message that includes an address for accessing the product use agreement. The method further includes receiving, from the user, a call at the address and audibly playing, to the user, a pre-recorded product use agreement recording. The pre-recorded product use agreement recording includes a legal agreement for using the product between the user and a business entity providing the product. The method further includes receiving, from the user, acceptance of the product use agreement based on the pre-recorded product use agreement recording, and providing access to the product based on acceptance of the product use agreement.

### BACKGROUND

Legal agreements are pervasive throughout society. For example, for a customer to use a software product or receive a product or a service, including software as a service, the customer often must first agree to a written legal agreement in order to have the benefit of the product. The legal agreement may be a license agreement, a terms of use agreement, a terms of service agreement, or any other legally binding document that specifies the agreement terms between the customer and the provider of the product.

Classically, the legal agreement was a physical written document. To agree to the legal agreement, the customer signs the written document with a signature, an ‘X’, or a fingerprint. The business providing the product retains the signed document and provides the customer with the product.

With the advent of software, shrink wrap agreements became a generally accepted and legally binding form of a legal agreement. In shrink wrap agreements, the terms of the legal agreement are visible on the outside of the package containing the software product. By its agreement terms, when the customer removes the shrink wrap, the customer is deemed to have accepted the terms. Because the software product is located inside the packaging, the customer must first agree to the terms (i.e., by removing the packaging) before the customer can access the software product.

Another form of a legal agreement is a click wrap agreement. A click wrap agreement is a textual document displayed on a computer. To accept the click wrap agreement, the customer selects an accept software button that refers to the textual agreement document. The selection of the button allows the customer to confirm having understood and agreed to the terms before proceeding with installing, downloading, accessing and/or using the product. The product may be a product, software, service or any combination thereof.

### SUMMARY

In general, in one aspect, the invention relates to a method for providing a product use agreement. The method includes sending, to a user in response to a request for a product, a message that includes an address for accessing the product use agreement. The method further includes receiving, from the user, a call at the address and audibly playing, to the user, a pre-recorded product use agreement recording. The pre-recorded product use agreement recording includes a legal agreement for using the product between the user and a business entity providing the product. The method further includes receiving, from the user, acceptance of the product use agreement based on the pre-recorded product use agreement recording, and providing access to the product based on acceptance of the product use agreement.

In general, in one aspect, the invention relates to a system for providing a product use agreement. The system includes a data repository that includes a pre-recorded product use agreement recording, a processor, and a product use agreement application, executing on the processor. The product use agreement application is configured to send, to a user in response to a request for a product, a message that includes an address for accessing the product use agreement. The product use agreement application is further configured to receive, from the user, a call at the address and audibly play, to the user, a pre-recorded product use agreement recording. The pre-recorded product use agreement recording includes a legal agreement for using the product between the user and a business entity providing the product. The product use agreement application is further configured to receive, from the user, acceptance of the product use agreement based on the pre-recorded product use agreement recording. The user is provided access to the product based on acceptance of the product use agreement.

In general, in one aspect, the invention relates to a computer readable medium that includes executable instructions for providing a product use agreement. When the executable instructions are executed by a processor, the processor performs a method. The method includes sending, to a user in response to a request for a product, a message that includes an address for accessing the product use agreement. The method further includes receiving, from the user, a call at the address and audibly playing, to the user, a pre-recorded product use agreement recording. The pre-recorded product use agreement recording includes a legal agreement for using the product between the user and a business entity providing the product. The method further includes receiving, from the user, acceptance of the product use agreement based on the pre-recorded product use agreement recording, and providing access to the product based on acceptance of the product use agreement.

Other aspects of the invention will be apparent from the following description and the appended claims.

### BRIEF DESCRIPTION OF DRAWINGS

FIG. 1 shows a schematic diagram of a system in accordance with one or more embodiments of the invention.

FIGS. 2-4 show flowcharts in accordance with one or more embodiments of the invention.

FIG. 5 shows an example in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for allowing a user access to a product based on a user's acceptance of an audible pre-recorded product use agreement recording. Specifically, when a user requests a product, a message with an address for accessing the product use agreement is provided to the user. When the user calls the address, the pre-recorded product use agreement recording is audibly played to the user. Thus, the user may listen to the product use agreement to determine whether to agree to the product use agreement. The user may accept the product use agreement by accepting the pre-recorded product use agreement recording. For example, the user may speak an acceptance or select one or more buttons to accept. After accepting the product use agreement, the user is granted access to the product. In one or more embodiments of the invention, the user may later request a copy of the product use agreement or call the address again to access the product use agreement again.

In one or more embodiments of the invention, the user may correspond to an individual, a business entity, an agent of the business entity, a family member, or any other entity that can accept a product use agreement. In one or more embodiments of the invention, the product may be a good or a service. For example, the product may be a software application, such as a financial application, healthcare application, a game, etc. As another example, the product may be a service that includes a software application component. As another example, the product may be a service, such as support service, financial management services, software as a service, etc.

In one or more embodiments of the invention, the product use agreement is a legal agreement that specifies the agreed to actions that the user and the vendor of the product will perform. For example, the product use agreement may be a license agreement, a terms of use agreement, a terms of service agreement, etc. In one or more embodiments of the invention, the product use agreement is divided into sections (e.g., license grant and restrictions section, reservation of rights and ownership section, help and support section, rights and obligations, disclaimers, etc.). Each section may have a heading and clauses. The clauses specify the terms to which the user must agree to use the product.

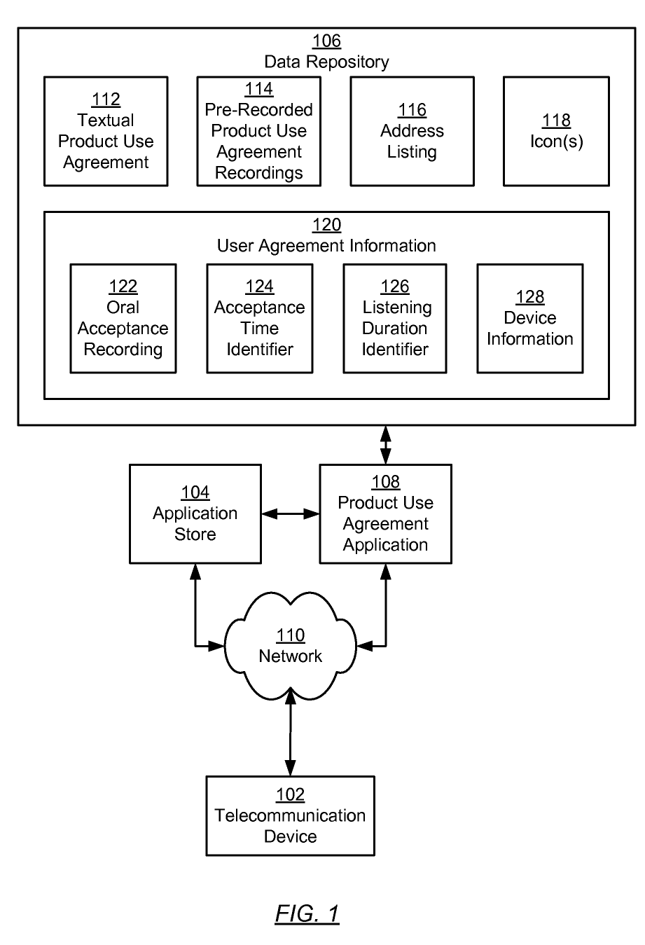

FIG. 1 shows a schematic diagram of a system in accordance with one or more embodiments of the invention. As shown in FIG. 1, the system includes a telecommunication device (102), an application store (104), a data repository (106), and a product use agreement application (108) in accordance with one or more embodiments of the invention. Each of these components is described below.

In one or more embodiments of the invention, a telecommunication device (102) is a physical device configured to audibly play the product use agreement. Specifically, the telecommunication device (102) may include an internal speaker and/or a connection device (e.g., physical port, Bluetooth connector, or other device) to connect to device containing a speaker (e.g., a wired headset, a Bluetooth headset, headphones, or other device containing a speaker). Further, in one or more embodiments of the invention, the telecommunication device (102) includes functionality to obtain the user's acceptance of the product use agreement and transmit acceptance via the network (110) (discussed below). For example, the telecommunication device (102) may correspond to a wired device (such as a telephone), electronic wireless devices (such as a mobile wireless electronic display), mobile handset or mobile phone (e.g., limited functionality mobile phone, a smart phone), a computer system, a landline telephone, or any other telecommunication device. For example, a limited functionality mobile phone corresponds to a wireless phone that does not include an Internet Browser. Such limited functionality phone may be referred to as a dumb phone. In one or more embodiments of the invention, the telecommunication device (102) is controlled, (e.g., owned, rented, borrowed, or otherwise operated) by the user.

In one or more embodiments of the invention, the telecommunication device (102) is connected to a network (110). A network is a collection of one or more devices that is configured to transmit data between at least two endpoints. For example, the network (110) may be a local area network, a wide area network, a telecommunication network, or any combination thereof.

In one or more embodiments of the invention, an application store (104) is connected to the network (110). In one or more embodiments of the invention, the application store (104) is an electronic commerce medium for providing products to users. For example, the application store (104) may include multiple software applications that the user may access via the Internet or other medium, and/or access from a user's local device. Further, the application store (104) may also include functionality to register users for products corresponding to services. Products in the application store (104) may be provided to one or more users complementary, as a gift from a user or company, or for purchase.

The application store (104) may provide the product to the telecommunication device (102) or to a second user's device (not shown) in accordance with one or more embodiments of the invention. Specifically, the second user's device may be configured to obtain or access the product and the telecommunication device (102) is configured to transmit the user's acceptance of the product use agreement. Alternatively, the telecommunication device (102) may be configured to both obtain or access the product and transmit acceptance of the product use agreement.

In one or more embodiments of the invention, the product use agreement is stored in a data repository (106). In one or more embodiments of the invention, the data repository (106) is any type of storage unit and/or device (e.g., a file system, database, collection of tables, or any other storage mechanism) for storing data. Specifically, the data repository may correspond to a hardware device (e.g., a server, hard disk, flash memory, or other physical device), a collection of hardware devices, or may be stored within a hardware device (e.g., a file in a file system of a hardware device). Further, the data repository (106) may include multiple different storage units and/or devices. The multiple different storage units and/or devices may or may not be of the same type or located at the same physical site.

In one or more embodiments of the invention, the data repository (106) includes functionality to store a textual product use agreement (112), pre-recorded product use agreement recordings (114), address listings (116), icon(s) (118), and user agreement information (120). In one or more embodiments of the invention, the textual product use agreement (112) is a text-based version of the product use agreement. Specifically, the textual product use agreement is in language based alphanumeric characters (e.g., English alphanumeric characters, Russian alphanumeric characters, Chinese alphanumeric characters, etc.) for visual display.

In one or more embodiments of the invention, pre-recorded product use agreement recordings (114) are audio voice recordings of the product use agreement. For example, the pre-recorded product use agreement recording may be a sound recording of a person (actual or synthesized) reading the product use agreement. In one or more embodiments of the invention, the person reading the product use agreement for the pre-recorded product use agreement recording is a local or global celebrity, such as a well-known film or voice actor, male, female, or other. Alternatively, the person reading the product use agreement may be a layperson. In one or more embodiments of the invention, a separate pre-recorded product use agreement recording (114) exists for each different language and/or dialect of one or more languages. For example, a separate pre-recorded product use agreement recording may be in English, Dutch, German, Finnish, Greek, Italian, Russian, Czech, Ukrainian, Serbian, and any other language.

In one or more embodiments of the invention, the address listing (116) is a collection of addresses for accessing each of the pre-recorded product use agreement recordings (114). Each address listed in the address listing (116) may be a phone number (e.g., a toll free number, local phone number, long distance phone number), a voice over internet protocol (VOIP) application address, an hypertext transfer protocol (http) address, or any other internet address, or other address to access a pre-recorded product use agreement recording (114). Further, in one or more embodiments of the invention, the address listing may include a uniform resource locator (URL) address to obtain a copy of the product use agreement and/or the pre-recorded product use agreement after the user's acceptance.

In one or more embodiments of the invention, the icon(s) (118) are stored images. Each image may have pictorial and/or textual elements. Each icon (118) may be a visual indicator of an available tool to use the product use agreement. Further, one or more icons may exist to represent a section within the product use agreement. For example, the available tools may be to fast forward, rewind or repeat, pause, stop, resume, and play the product use agreement. In the example, the available tools may be represented with a forward arrow icon, a backward arrow icon, vertical parallel lines icon, a square icon, and a triangle icon, respectively. As another example, the available tools may also or alternatively include a hardware or software acceptance button indicating the user has understood and agreed, and a hardware or software rejection button to reject indicating the user does not agree, respectively, to the product use agreement. In the example, the acceptance button may be represented as a green checkmark icon while the rejection button is represented as a red “X” icon.

Alternatively or additionally, icon(s) and or auditory instructions may be played or displayed to instruct a user how to orally accept or reject the product use agreement. For example, instructions may be stored that informs the user to either accept or reject the product use agreement using buttons or by speaking acceptance or rejection.

Alternatively or additionally, icons may exist to visually denote the difference between the sections. For example, while the product use agreement is audibly played for the user, an icon may be presented that visually indicates the section that is being audibly played for the user.

In one or more embodiments of the invention, the user agreement information (120) corresponds to information about the user. Specifically, the user agreement information (120) stores information to prove the user's acceptance or rejection of the product use agreement. In one or more embodiments of the invention, the user agreement information (120) may include an oral acceptance recording (122), an acceptance time identifier (124), a listening duration identifier (126), and device information (128).

In one or more embodiments of the invention, the oral acceptance recording (122) is an audio recording of the user orally accepting the product use agreement. Specifically, when the user speaks an acceptance of the product use agreement, the sound the user accepting the product use agreement is recorded and stored in accordance with one or more embodiments of the invention.

In one or more embodiments of the invention, the acceptance time identifier (124) identifies the date and time that the user accepted the product use agreement as required to use the product. The acceptance time may be listed in any time zone, such as the local time zone of the user, vendor, or geographic site of the data repository, or Greenwich Mean Time (GMT).

In one or more embodiments of the invention, the listening duration identifier (126) identifies the amount of time in which the user listened to the pre-recorded product use agreement recording. For example, the listening duration identifier (126) may include a total time indicator, a per section duration indicator, a maximum position indicator, another indicator for recording time, or a combination thereof. The total time indicator indicates the difference between the time at which the product use agreement finished playing for the user and the time at which the pre-recorded product use agreement recording started playing for the user. The difference may be further decreased by the amount of time that the user paused the pre-recorded product use agreement recording. A per section duration indicator defines how long each section of the product use agreement was played to the user. A maximum position indicator defines the maximum position within the pre-recorded product use agreement recording (e.g., by elapse time, by clause in product use agreement) that was played to the user.

The following is an example of the listening duration identifier in accordance with one or more embodiments of the invention. For the following example, consider the scenario in which the pre-recorded product use agreement recording spans a total fifteen minutes. In the example, a user starts listening to the pre-recorded product use agreement recording at noon GMT on the first of January, 2010 and listens for ten minutes. During the ten minutes, the user paused the product use agreement for three minutes, and replayed the two minutes of the product use agreement. In the example, the listening duration identifier may identify that the user listened to five minutes of the pre-recorded product use agreement recording (i.e., ten minutes total—three minutes paused—two minutes replayed=five minutes), listened to sections twice, had a maximum position of a clause, started listening to the recording on Jan. 1, 2010 at noon GMT, and accepted at Jan. 1, 2010 at 12:10 PM GMT.

In one or more embodiments of the invention, the device information (128) includes an identifier of the telecommunication device (102). For example, the identifier of the telecommunication device may correspond to a hardware identifier, a software address (e.g., a phone number) of the telecommunication device, or other information that uniquely identifies the telecommunication device (102). Further, the device information (128) may include information about one or more authorized device(s). An authorized device is a device (e.g., telecommunication device, the user's second device) that is permitted access to the product based on the user's acceptance of the product use agreement.

Although not shown in FIG. 1, the user agreement information (120) may also include user identification information. In one or more embodiments of the invention, the user identification information uniquely identifies the user. For example, the user identification information may be a login name, a social security number, a drivers license, and/or another identifier. In one or more embodiments of the invention, the user agreement information (120) further includes a confirmation that the user was authenticated prior to accepting the product use agreement.

Continuing with FIG. 1, in one or more embodiments of the invention, data repository (106) and the application store (104) is connected to the product use agreement application (108). In one or more embodiments of the invention, the product use agreement application (108) is configured to provide the pre-recorded product use agreement recording to users, store user agreement information in the data repository, and allow access to the product based on the user's acceptance of the pre-recorded product use agreement recording. Specifically, the product use agreement application (108) is configured to provide the audio pre-recorded product use agreement recording to the telecommunication device (102). In one or more embodiments of the invention, the product use agreement application (108) may be further configured to unlock the product or inform the application store (104) to unlock the product after receiving the user's acceptance of the product use agreement.

Although not shown in FIG. 1, in one or more embodiments of the invention, the telecommunication device (102) may store one or more pre-recorded product use agreement recordings (114). Specifically, the pre-recorded product use agreement recording corresponding to the user's language may be stored locally on the telecommunication device (102). The storage on the telecommunication device (102) may occur prior to the user requesting the product from the application store (104) or requesting access to the product. For example, a general pre-recorded product use agreement recording may exist for all or a portion of products in the application store (104). This general pre-recorded product use agreement recording may be pre-stored on the telecommunication device (102). The general pre-recorded product use agreement recording may further be periodically updated, such as by the vendor of the product. In such a scenario, the address provided to the user may correspond to a local address on the telecommunication device (102), such as the name of a file, for the user to access the general pre-recorded product use agreement recording. In one or more embodiments of the invention, playing the pre-recorded product use agreement recording from the local address constitutes calling the address.

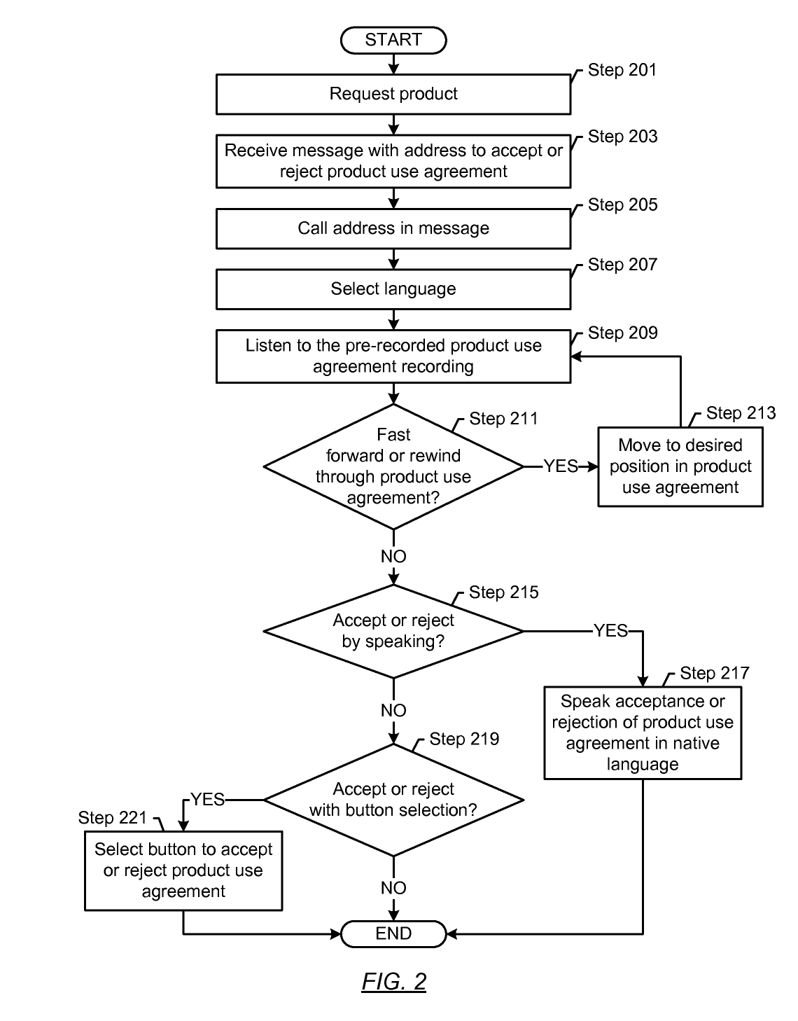

FIGS. 2-4 show flowcharts in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel.

FIG. 2 shows a flowchart for a user to interact with the pre-recorded product use agreement recording in accordance with one or more embodiments of the invention. In Step 201, the user requests the product. Different mechanisms may be used to allow the user to request the product. For example, the user may request the product by selecting the product from the application store, obtain the product from a vendor, obtain a device in which the product is pre-loaded and open the product, select a link to the product, request the product from a representative of the product, or other such mechanism.

In Step 203, the user receives a message with an address to accept or reject the product use agreement. In one or more embodiments of the invention, after the user requests the product, the user is provided with the address. For example, if the product is a software application to be locally executed, the user may download the product on the user's device. During or after installation and before activation, the user may be provided with the message having the address. Alternatively, the user may be provided with the message when the user registers the product or registers for the product. In one or more embodiments of the invention, the message is a displayed message. For example, the message may be in a text message, a dialog box, or another form of user interface message. Alternatively, the message may be an audio recording speaking the address. As discussed above, the message may or may not be received by the user's telecommunication device. For example, if the user requests the product using a different device than the telecommunication device, then the message may be provided to the different device. As another example, if the user provides an address of the telecommunication device, such as during registration of the user or the product, the message may be sent directly to the user's telecommunication device.

In Step 205, the user's telecommunication device calls the address referenced in the message. In one or more embodiments of the invention, the user requests that the telecommunication device calls the address. The user may request the telecommunication device calls the address by selecting the address using the telecommunication device interface, dialing the address when the address is a phone number, typing in the address in the telecommunication device, selecting a software button that has a link to the location specified by the address, or performing another technique. In one or more embodiments of the invention, the user may not immediately call the address referenced in the message. For example, the user may decide to delay listening to the pre-recorded product use agreement recording for several hours, days, etc. In one or more embodiments of the invention, if the user delays listening to the product use agreement, then the user may be provided with limited or no access to the product.

In one or more embodiments of the invention, after calling the address, the telecommunication device is connected to the product use agreement application. The connection allows the product use agreement application to provide information to the user. In one or more embodiments of the invention, upon connection, the user is guided through one or more menus. For example, the menus may be displayed on the telecommunication device or the user may be audibly guided through the menus. As the user is guided, the user may make a selection using the interface of the telecommunication device. For example, the user may select hardware or software buttons or the user may speak the selection.

In Step 207, the user selects a language using the telecommunication device. In one or more embodiments of the invention, one of the menus played for the user is a language selection menu. Thus, the user may select the native language of the user. The selection may be transmitted between the telecommunication device and the product use agreement application. Rather than selecting a language, the user may use a default language. Further, the user may switch between languages, such as from a default language to another language, in accordance with one or more embodiments of the invention.

In Step 209, the user listens to a pre-recorded product use agreement recording. Specifically, the pre-recorded product use agreement recording is audibly played by the telecommunication device to the user. Because the pre-recorded product use agreement recording is audibly played, the user may perform other actions while listening to the recording. For example, the user may drive a car, exercise, take care of children, review unrelated documents, or perform a myriad of other actions.

In Step 211, the user determines whether to fast forward or rewind through the product use agreement. Specifically, while listening to the pre-recorded product use agreement recording, the user may decide to skip a section or clause or listen to a section or clause again. In one or more embodiments of the invention, the product use agreement application allows the user to fast forward or rewind through the product use agreement. Accordingly, if the user decides to fast forward or rewind, then, in Step 213, the user moves to the desired position in the product use agreement in accordance with one or more embodiments of the invention. For example, the user may select a hardware or software button, voice command, or other user interface component to fast forward or rewind through the product use agreement recording. In one or more embodiments of the invention, the product use agreement application allows the user to skip to a desired section with a selection of a button. Alternatively, the product use agreement application may require that the user continually press a button for the user to listen to the text within intermediate sections albeit at a faster rate. Thus, in Step 209, the user may continue to listen to the pre-recorded product use agreement recording starting at the desired position.

Continuing with FIG. 2, in Step 215, the user determines whether to accept or reject the product use agreement by speaking in accordance with one or more embodiments of the invention. Specifically, while or after listening to the product use agreement, the user may decide whether to accept the product use agreement. In Step 217, if the user decides to accept or reject the product use agreement by speaking, then the user speaks the acceptance or rejection of the product use agreement. In one or more embodiments of the invention, the user is provided with instructions of how the user may orally accept or reject the product use agreement. For example, the user may be provided with the word or phrase in the user's selected language necessary to confirm acceptance, such as “I accept”, “I agree”, “accept”, “yes”, “I agree to the terms of this agreement”, “I reject”, “I disagree”, “reject”, “no”, “I reject the terms of this agreement”, or another accepting or rejecting word or phrase. Thus, in one or more embodiments of the invention, the user may speak the provided words to accept or reject the product use agreement.

Alternatively, if the user decides not to speak acceptance or rejection of the product use agreement, in Step 219, the user determines whether to accept or reject the product use agreement with a button selection. Specifically, in one or more embodiments of the invention, the user may accept or reject the pre-recorded product use agreement by selecting hardware or software buttons on the user's telecommunication device. If the user decides to accept or reject the product use agreement using the button selection, then the user selects either the accept or reject button in Step 221. Similar to oral acceptance, the user may be provided with textual or oral instructions of how the user may accept or reject the product use agreement using buttons. For example, an icon may be displayed on the user's telecommunication device that indicates the buttons to press to accept the product use agreement or to reject the product use agreement. As another example, the instructions may indicate to the user a series of buttons to select to accept or reject the product use agreement, such as “*” button, “Y” button, “E” button, “S” button (*937) to accept or “#” button, “N” button, “0” button (#66) to reject. Thus, in one or more embodiments of the invention, the user may select the corresponding buttons to accept or reject the product use agreement.

Alternatively, the user may decide to end communication with the product use agreement application without accepting or rejecting the product use agreement (not shown). In such a scenario, the user may call the address at a later time to complete the acceptance or rejection of the product use agreement application.

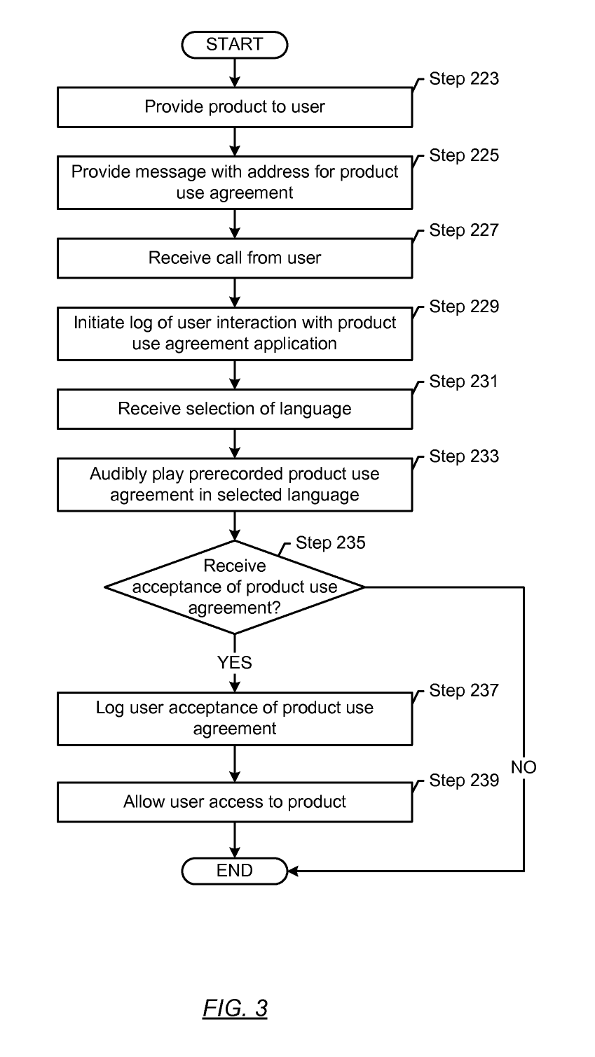

FIG. 3 shows a flow diagram for allowing access to a product in accordance with one or more embodiments of the invention. In Step 223, a product is provided to the user. For example, the application store may send the product to the user, allow the user to register for the product, accept payment for the product, or perform other such actions. In one or more embodiments of the invention, if the product is provided to the user prior to receiving acceptance from the user of the product use agreement, then the product is not activated. Specifically, the user is denied access to the product, and therefore cannot use the product, until after the user accepts the product use agreement. Alternatively, the product may only be provided to the user after the user accepts the product use agreement. In such embodiments, a request requesting access to the product from the user may be received and trigger providing the message.

In Step 225, a message with the address for the product use agreement is provided to the user. In one or more embodiments of the invention, in order to provide the message, the product use agreement application determines the region (e.g., city, state, country, territory) in which the user is geographically located. In one or more embodiments of the invention, based on the region, the product use agreement application selects an address corresponding to the region. The address may correspond to the region, for example, because the address is a local or toll-free number for the region, or because the address is connected to a version of the pre-recorded product use agreement recordings in the languages commonly spoken in that region. Once the address is selected, the address is transmitted to the user in a message. For example, the address may be transmitted to the user in a displayed message, in a text message, or in another such message.

In Step 227, a call is received from the user in accordance with one or more embodiments of the invention. In one or more embodiments of the invention, the call is received by the product use agreement application. Thus, the call is received by an automated system in accordance with one or more embodiments of the invention.

In Step 229, based on the call, the product use agreement application initiates a log of the user's interactions with the product use agreement application. For example, the product use agreement application may create a storage space in the data repository for the user agreement information for the user that called. The product use agreement application may begin populating the user agreement information by detecting device information from the telecommunication device and storing the device information in the data repository. Further, the product use agreement application may start a timer to determine the listening duration.

In Step 231, the product use agreement application receives a selection of the language. In one or more embodiments of the invention, the product use agreement application provides the user with options of languages corresponding to the address. In one or more embodiments of the invention, the optional languages are presented to the user in the corresponding language. Accordingly, after the user selects the language, the product use agreement application begins presenting information (e.g., instructions of how to accept or reject the product use agreement, pre-recorded product use agreement recording, and other information) to the user in the selected language.

In Step 233, the product use agreement application audibly plays the pre-recorded product use agreement recording corresponding to the selected language. While the product use agreement application plays the pre-recorded product use agreement recording, the product use agreement application may receive a selection from the user to fast-forward, rewind, pause, or stop playing. In such scenario, the product use agreement application moves to the selected position, pauses playing, or stops playing, and updates the log to reflect the user's requests. By updating the log, the product use agreement application may store the listening duration information from the log into the data repository. Thus, the data repository may retain a record of how the user listened to the pre-recorded product use agreement recording.

In Step 235, a determination is made whether the product use agreement application received acceptance of the product use agreement. Specifically, if the product use agreement application detects acceptance or rejection input from the user, then the product use agreement application may stop audibly playing the pre-recorded product use agreement. In another example, if the product use agreement application finishes playing the pre-recorded product use agreement recording, then the product use agreement application may prompt the user for acceptance or rejection of the product use agreement.

In one or more embodiments of the invention, if the product use agreement application receives acceptance of the product use agreement based on the pre-recorded product use agreement recording, then the product use agreement application logs the user's acceptance of the product use agreement in Step 237. Specifically, the product use agreement application may store a recording of the user orally accepting the product use agreement in the data repository. The product use agreement application may further log the time and date of acceptance and update the listening duration identifier with the logged information.

In Step 241, based on the user's acceptance of the product use agreement, the product use agreement application allows the user access to the product. At this stage, the product is activated and the user may begin using the product.

Alternatively, if in Step 235, the user rejects or does not accept the product use agreement, then the product use agreement application may erase the user's agreement information in the data repository or complete the user's agreement information stored in the data repository to show that the user rejected or did not accept the product use agreement. Further, in one or more embodiments of the invention, the user is continued to be denied access to the product based on the user's lack of acceptance of the product use agreement. In one or more embodiments of the invention, if the user rejects the product use agreement, then the rejection may trigger a refund of the amount paid for the product.

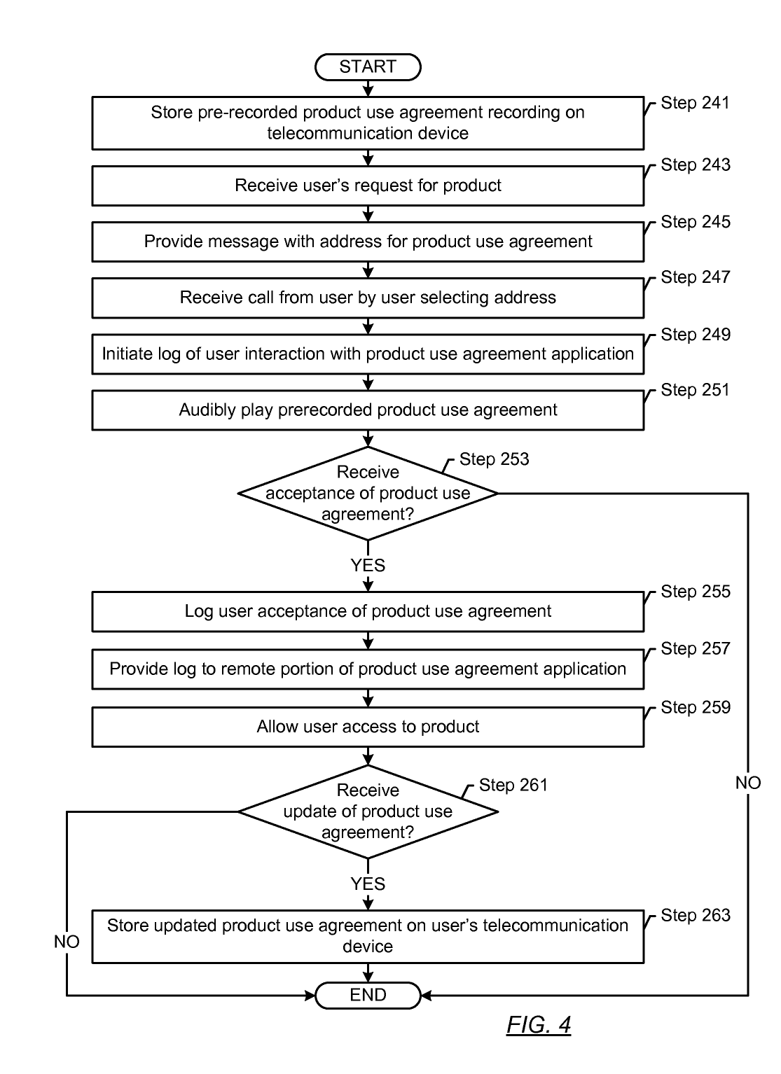

As discussed above, with reference to FIG. 1, as an alternative to the pre-telecommunication recorded product use agreement being remotely stored from the device, the pre-recorded product use agreement may be locally stored on the telecommunication device. FIG. 4 shows a flowchart for a product use agreement application that is locally executed on the telecommunication device in accordance with one or more embodiments of the invention.

In Step 241, a pre-recorded product use agreement recording is stored on the telecommunication device. In one or more embodiments of the invention, the pre-recorded product use agreement recording may be stored, for example, by the vendor or manufacturer of the telecommunication device. The storage may occur, for example, prior to the user receiving the telecommunication device. Alternatively, the pre-recorded product use agreement recording may be stored on the telecommunication device the first time that the user accesses the application store or with the first product that the user obtains from the application store. Accordingly, the pre-recorded product use agreement recording is available for subsequent products.

In Step 243, a user's request for the product is received in accordance with one or more embodiments of the invention. Specifically, local portion of the product use agreement application may receive an indicator from the telecommunication device, the application store, or the remote portion of the product use agreement application that the user is requesting a product.

In Step 245, the local portion of the product use agreement application provides the user with a message that includes an address for the product use agreement. The message may be provided, for example, in a dialog box. Further, the address may be a local address on the telecommunication device. For example, the address may be in the form of a link, such as a software button that includes a link to the local storage location of the pre-recorded product use agreement recording.

In Step 247, a call is received at the address in accordance with one or more embodiments of the invention. Specifically, the user requests to open the pre-recorded product use agreement recording.

In Step 249, the receipt of the call triggers a log to be initiated of the user's interaction with the product use agreement application. In one or more embodiments of the invention, only the local portion of the product use agreement application begins logging the user's interaction. Thus, the telecommunication device does not need to be connected to a network and, therefore, to the remote product use agreement application while the user is listening to the pre-recorded product use agreement recording in accordance with one or more embodiments of the invention.

In Step 251, the local portion of the product use agreement application audibly plays the locally stored pre-recorded product use agreement recording. As discussed above, while the product use agreement application plays the pre-recorded product use agreement recording, the product use agreement application may receive a selection from the user to fast-forward, rewind, pause, or stop playing. In such scenario, the product use agreement application moves to the selected position, pauses or stops playing, and updates the log to reflect the user's requests.

In Step 253, a determination is made whether the product use agreement application received acceptance of the product use agreement. Specifically, if the local portion of the product use agreement application detects acceptance or rejection input from the user, then the product use agreement application may stop audibly playing the pre-recorded product use agreement. In another example, if the product use agreement application finishes playing the pre-recorded product use agreement recording, then the product use agreement application may prompt the user for acceptance or rejection of the product use agreement.

In one or more embodiments of the invention, if the product use agreement application receives acceptance of the product use agreement based on the pre-recorded product use agreement recording, then the product use agreement application logs the user's acceptance of the product use agreement in Step 255. For example, the local portion of the product use agreement application may store a recording of the user orally accepting the product use agreement. The local portion of the product use agreement application may further log the time and date of acceptance and update the listening duration identifier with the logged information.

In Step 257, the local portion of the product use agreement application provides the log to the remote portion of the product use agreement application. Specifically, in one or more embodiments of the invention, the next time that the telecommunication device can connect to a network after receiving the user's acceptance, the local portion of the product use agreement application uses the connection to transfer the log to the remote portion of the product use agreement application. In one or more embodiments of the invention, the local portion of the product use agreement application waits for confirmation that the remote portion received the log before continuing. Further, the remote portion may store in the database the user's acceptance information in the log.

In Step 259, based on the user's acceptance of the product use agreement, the local portion of the product use agreement application allows the user access to the product. At this stage, the product is activated and the user may begin using the product.

In one or more embodiments of the invention, the product use agreement may be occasionally updated to reflect new or modified sections. In such embodiments, an updated recording of the product use agreement recording is created. Further, the remote portion of the product use agreement application may provide the update to the telecommunication device. In Step 261, the local portion of the product use agreement application determines whether an update of the product use agreement is received. If an update is received, then the updated pre-recorded product use agreement recording is stored on the telecommunication device in Step 263. Thus, the next time that the user requests a product, the updated version of the pre-recorded product use agreement recording is audibly played for the user.

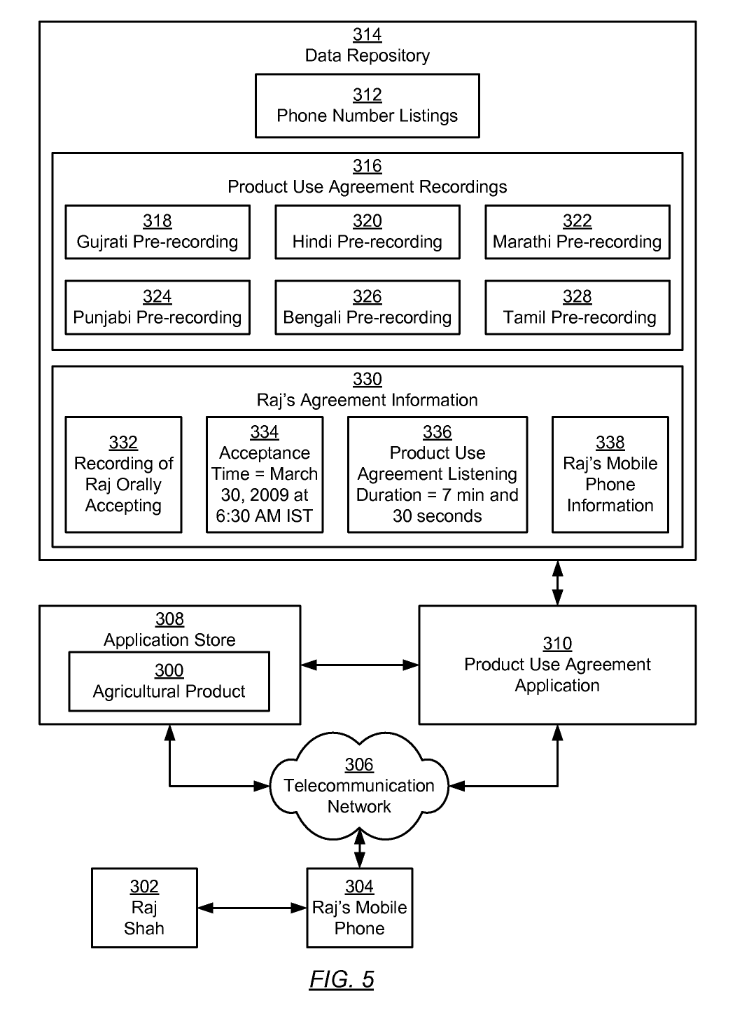

FIG. 5 shows an example in accordance with one or more embodiments of the invention. The example shown in FIG. 5 is for explanatory purposes only and not intended to limit the scope of the invention. In the example, consider the scenario in which an agricultural product (300) is provided to rural farmers in India. Specifically, the agricultural product (300) is service for use on limited functionality phones. The agricultural product (300) provides prices to farmers to purchase raw materials and the price of their goods on the market. In the example, consider the scenario in which Raj Shah (302) is one of the farmers registering for the agricultural product (300). Raj Shah (302) lives in a remote farming community with no computers and has only his limited functionality mobile phone (304). He uses his limited functionality mobile phone (304) to connect via the telecommunication network (306) to the application store (308) and to register for the agricultural product (300).

Continuing with the example, after registering for the agricultural product (300), the application store (308) or the product use agreement application (310) searches the phone number listings (312) in the data repository (314) to identify a phone number that is local to Raj Shah (302) and generates a text message with the local phone number. Accordingly, Raj Shah (302) receives the text message via the telecommunication network (306) on his mobile phone (302). The text message informs Raj Shah (302) that he must first listen and accept a product use agreement and includes an address in the form of the local telephone number for accessing the product use agreement application (310). Accordingly, Raj Shah (302) uses his mobile phone (304) to call the phone number provided in the text message.

In the example, when the product use agreement application (310) receives a call from Raj Shah, the product use agreement application (310) plays a pre-recorded message requesting Raj Shah to select a language from a collection of languages spoken in India. Specifically, in the example, the product use agreement recordings (316) include a Gujrati pre-recording (318), a Hindi pre-recording (320), a Marathi pre-recording (322), a Punjabi pre-recording (324), a Bengali pre-recording (326), and a Tamil pre-recording (328). Because Raj's native language in the example is Tamil, Raj requests the Tamil pre-recording (328) by selecting the hardware “6” button on his mobile phone (304). Accordingly, while Raj listens to the pre-recorded product use agreement recording in the Tamil language, Raj determines whether he would like to accept the product use agreement. After deciding to accept the product use agreement, Raj says “I accept” in the Tamil language.

Continuing with the example, in response to the acceptance, the product use agreement application (310) stores Raj's agreement information (330) in the data repository (314). Specifically, the product use agreement application (310) stores the voice recording of Raj orally accepting the product use agreement (332), the time that Raj accepted as being the local time of Mar. 30, 2009 at 6:30 AM India Standard Time (IST) (334), the amount of time that Raj listened to the product use agreement as seven minutes and thirty seconds (336), and mobile phone information (338) about Raj's mobile phone (304). Further, in response to the acceptance, the product use agreement application (310) allows Raj (302) access to the agricultural product (300). Thus, Raj (302) may use the agricultural product (300) and the product use agreement application (310) has proof of Raj's acceptance of the product use agreement.

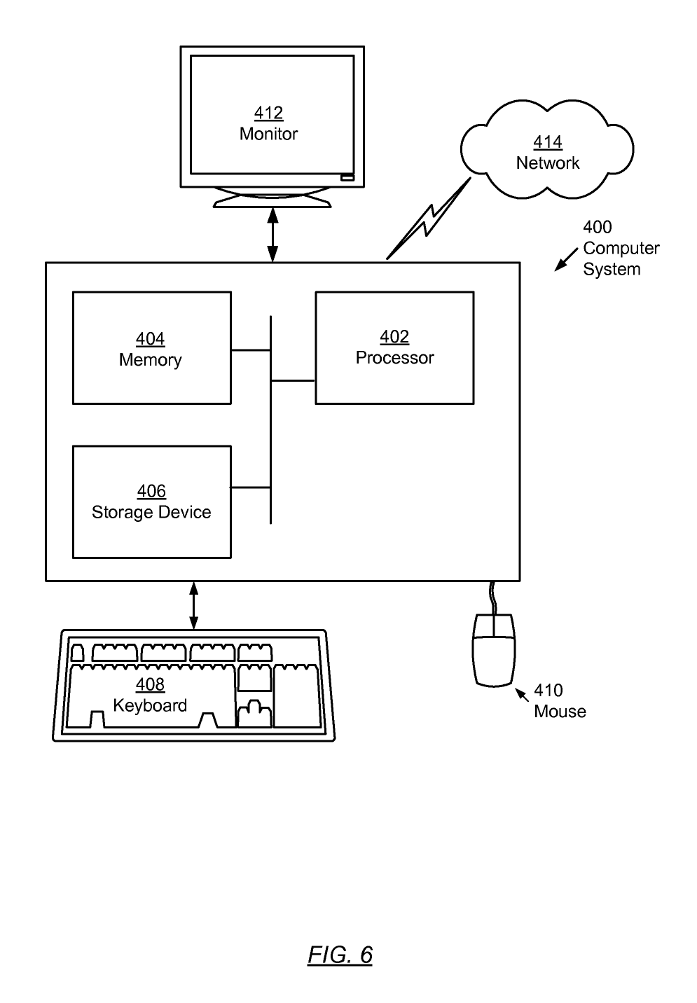

Embodiments of the invention may be implemented on virtually any type of computer regardless of the platform being used. For example, as shown in FIG. 6, a computer system (400) includes one or more processor(s) (402), associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). In one or more embodiments of the invention, the processor (402) is hardware. For example, the processor may be an integrated circuit. The computer system (400) may also include input means, such as a keyboard (408), a mouse (410), or a microphone (not shown). Further, the computer system (400) may include output means, such as a monitor (412) (e.g., a liquid crystal display (LCD), a plasma display, or cathode ray tube (CRT) monitor). The computer system (400) may be connected to a network (414) (e.g., a local area network (LAN), a wide area network (WAN) such as the Internet, or any other type of network) via a network interface connection (not shown). Those skilled in the art will appreciate that many different types of computer systems exist, and the aforementioned input and output means may take other forms. Generally speaking, the computer system (400) includes at least the minimal processing, input, and/or output means necessary to practice embodiments of the invention.

Further, those skilled in the art will appreciate that one or more elements of the aforementioned computer system (400) may be located at a remote location and connected to the other elements over a network. Further, embodiments of the invention may be implemented on a distributed system having a plurality of nodes, where each portion of the invention (e.g., user agreement information, product use agreement pre-recordings, application store, product use agreement application, etc.) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a computer readable medium, such as a compact disc (CD), a diskette, a tape, memory, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for providing a product use agreement, comprising:
sending, to a user in response to a request for a product, a message comprising an address for accessing the product use agreement;
receiving, from the user, a call at the address;
audibly playing, to the user, a pre-recorded product use agreement recording, wherein the pre-recorded product use agreement recording comprises a legal agreement for using the product between the user and a business entity providing the product;
receiving, from the user, acceptance of the product use agreement based on the pre-recorded product use agreement recording; and
providing access to the product based on acceptance of the product use agreement.

2. The method of claim 1, wherein the pre-recorded product use agreement recording is stored on a telecommunication device of the user prior to the user ordering the product.

3. The method of claim 1, further comprising:
presenting to the user a plurality of languages corresponding to a geographic region where the user is located, wherein the plurality of languages are obtained based on the address; and
receiving, from the user, a selection of a language from the plurality of languages, wherein the pre-recorded product use agreement recording is in the selected language.

4. The method of claim 1, further comprising:
audibly replaying at least a portion of the pre-recorded product use agreement recording in response to a request from the user to rewind.

5. The method of claim 1, further comprising:
fast forwarding through at least a portion of the pre-recorded product use agreement recording in response to a request from the user to fast-forward.

6. The method of claim 1, wherein the pre-recorded product use agreement recording is divided into a plurality of sections, and wherein providing the product use agreement comprises:
displaying on a mobile phone of the user an icon corresponding to each section of the plurality of sections while the section is audibly played.

7. The method of claim 1, further comprising:
storing a recording of the user speaking the acceptance of the product use agreement.

8. The method of claim 1, wherein the user accepts the product use agreement by selecting a series of buttons.

9. The method of claim 1, further comprising:
storing the acceptance, a time of the acceptance, and a time duration, wherein the time duration is an amount of time that the user listened to the product use agreement before accepting the product use agreement.

10. The method of claim 1, wherein the address is a telephone number, and wherein the telecommunication device is a mobile phone.

11. A system for providing a product use agreement, comprising:
a data repository comprising a pre-recorded product use agreement recording;
a processor; and
a product use agreement application, executing on the processor, and configured to:
send, to a user in response to a request for a product, a message comprising an address for accessing the product use agreement;
receive a call at the address;
audibly play a pre-recorded product use agreement recording, wherein the pre-recorded product use agreement recording comprises a legal agreement for using the product between the user and a business entity providing the product;
receive, from the user, acceptance of the product use agreement based on the pre-recorded product use agreement recording; and
provide access to the product based on acceptance of the product use agreement.

12. The system of claim 11, wherein the product use agreement is further configured to:
presenting to the user a plurality of languages corresponding to a geographic region where the user is located, wherein the plurality of languages are obtained based on the address; and
receiving a selection of a language from the plurality of languages, wherein the pre-recorded product use agreement recording is in the selected language.

13. The system of claim 11, wherein the product use agreement is further configured to:
audibly replaying at least a portion of the pre-recorded product use agreement recording in response to a request from the user to rewind.

14. The system of claim 11, wherein the product use agreement is further configured to:
fast forwarding through at least a portion of the pre-recorded product use agreement recording in response to a request from the user to fast-forward.

15. The system of claim 11, wherein the pre-recorded product use agreement recording is divided into a plurality of sections, and wherein providing the product use agreement comprises:
display on a mobile phone of the user an icon corresponding to each section of the plurality of sections while the section is audibly played.

16. The system of claim 11, wherein the data repository is further configured to:
store a recording of the user speaking the acceptance of the product use agreement.

17. The system of claim 11, wherein the product use agreement is further configured to:
store, in the data repository, the acceptance, a time of the acceptance, and a time duration, wherein the time duration is an amount of time that the user listened to the product use agreement before accepting the product use agreement.

18. A computer readable medium comprising executable instructions for providing a product use agreement, which when executed by a processor performs a method, the method comprising:
sending, to a user in response to a request for a product, a message comprising an address for accessing the product use agreement;
receiving, from the user, a call at the address;
audibly playing, to the user, a pre-recorded product use agreement recording, wherein the pre-recorded product use agreement recording comprises a legal agreement for using the product between the user and a business entity providing the product;
receiving, from the user, acceptance of the product use agreement based on the pre-recorded product use agreement recording; and
providing access to the product based on acceptance of the product use agreement.

19. The computer readable medium of claim 18, wherein the pre-recorded product use agreement recording is stored on a mobile device of the user prior to the user ordering the product.

20. The computer readable medium of claim 18, wherein the method further comprises:
storing a recording of the user speaking the acceptance of the product use agreement.
